(19) United States
(12) Patent Application Publication
(10) Pub. No.: US 2004/0081860 A1
(43) Pub. Date: Apr. 29, 2004

(54) Thin-film battery equipment

(75) Inventors: Michael J. Hundt, Double Oak, TX (US); Frank J. Sigmund, Coppell, TX (US)

Correspondence Address: STMICROELECTRONICS, INC., MAIL STATION 2346, 1310 ELECTRONICS DRIVE, CARROLLTON, TX, 75006, US

(73) Assignee: STMicroelectronics, Inc., Carrollton, TX

(21) Appl. No.: 10/284,424

(22) Filed: Oct. 29, 2002

(51) Int. Cl. H01M 2/02; H01M 10/04

(52) U.S. Cl. 429/7; 429/162

(57) ABSTRACT

In one embodiment, an apparatus includes but is not limited to: a thin-film battery affixed to at least one surface; and a device affixed to the thin-film battery.

### BACKGROUND OF THE APPLICATION

1. Field of the Application

The present application relates to equipment that incorporates electronic devices that utilize battery power.

2. Description of the Related Art

An electronic device is a machine that performs work using power supplied, at least in part, in the form of the flow of electrons. A battery is a device that consists of one or more cells (a cell is a device that converts a store of chemical energy into electrical energy) that are connected to act as a source of electric power. A rechargeable battery is a device whose one or more cells can be substantially reenergized once the store of chemical energy in the rechargeable battery has been partially or completely depleted.

An electronic device which utilizes battery power is one in which the electronic power supplied to the device comes at least in part from a battery. One type of electronic device that utilizes battery power is an integrated circuit, such as a memory circuit, a DC-DC converter, or a processor.

A variety of equipment incorporates electronic devices that utilize batteries. Examples of such equipment are portable computers, portable computer peripherals, personal digital assistants (PDAs), cellular phones, and cameras.

### BRIEF DESCRIPTION OF THE SEVERAL VIEWS OF THE DRAWINGS

FIG. 1 shows a side-plan view of apparatus 100.

FIG. 2 shows an illustrative example of thin-film battery 102 used in one embodiment of the present invention.

FIG. 3 shows one implementation of surface 104 in one embodiment of the present invention.

FIG. 4 depicts a side-plan view of a structure that may be used to create an implementation of surface 104 using substrate 108.

FIGS. 5A-5C illustrate side-plan views of structures representative of a method for constructing, at a substantially high temperature, a device having a thin-film battery.

The use of the same symbols in different drawings typically indicates similar or identical items.

### DETAILED DESCRIPTION OF THE APPLICATION

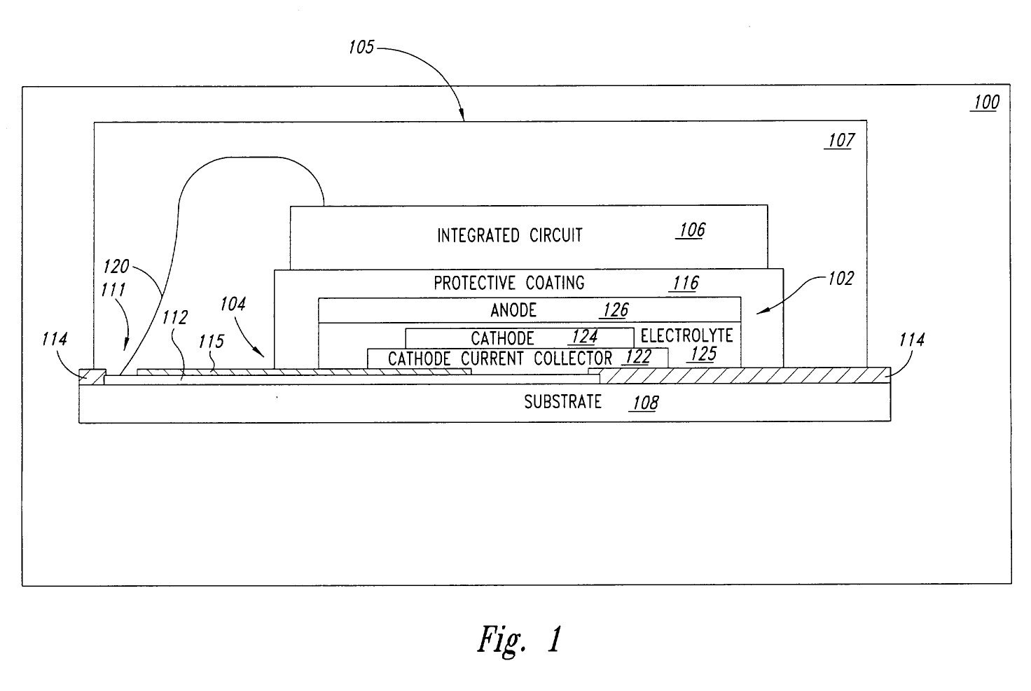

FIG. 1 shows a side-plan view of apparatus 100. Apparatus 100 has incorporated within it an integrated circuit and battery unit 105. The circuit unit 105 includes a thin-film battery 102 affixed to surface 104 and an integrated circuit 106 overlying the battery 102.

In a typical embodiment of the present invention, apparatus 100 is an electronic system that has circuitry in need of battery-supplied electric power, such as a wireless system or a computer system. Examples of such wireless systems include but are not limited to wireless phones, wireless handheld computers, wireless modems, wireless email units, and wireless Global Positioning System locators. Examples of such computer systems include but are not limited to handheld computer systems, personal computer systems, workstation computer systems, minicomputer systems, and mainframe computer systems.

In many embodiments, the apparatus 100 is of a type that requires extremely low power for operation or low power for retention of data. Typically, the battery 102 provides 5 volts, or alternatively 3.6 volts, depending on the application and integrated circuit used. The integrated circuit may be of the type used in a smart card which has very low power requirements for data retention. The battery 102 may thus be the power supply for the smart card or ensure that data is retained in the smart card. The integrated circuit may include a clock circuit and a clock time retention circuit to maintain accurate time when all other power supplies are removed. The apparatus may also be of a low power memory type, such as an SRAM, a TAG RAM or some other data storage device which is desired to remain programmable but have local battery power capability. In many applications, such as a wireless phone, a modem, a GPS system or the like, the battery 102 will be a backup battery for maintaining system operation or storage of data for brief periods of time in the event main power supply fails. The battery 102 may be used in combination with other power supply systems if the apparatus 100 is of the type which consumes large amounts of power and is connected to main line power and has one or more main battery power supplies and battery 102 is a third level backup power supply or alternative power supply.

In some combinations, the battery 102 is the primary power supply, such as in a smart card, and may, in some instances, be the sole source of battery storage. It may potentially be the sole source of electrical power during certain times of operation of the integrated circuit 106 and of the apparatus 100. The battery 102 may be charged during normal operation of the device and then be used to power only certain components at selected times within the overall system 100, such as the integrated circuit 106 while other portions of the circuit obtain their power from different sources.

In a typical embodiment of the present invention, surface 104 is a surface formed from one or more structures used in a semiconductor product. Examples of such surfaces include but are not limited to surfaces of semiconductor package substrates, surfaces of semiconductor substrates, surfaces of integrated circuit packages, and surfaces formed as a combination of other surfaces. For example, FIG. 1 shows surface 104 as a non-flat surface made up of a conductive trace 112 and dielectric layers 114 and 115. In addition, in various other embodiments of the present invention surface 104 may be a flexible, rigid, flat, or irregular surface.

Continuing to refer to FIG. 1, device 106 is affixed to thin-film battery 102 via coating 116. In some embodiments of the present invention, device 106 is an integrated circuit, and in such embodiments the substrate that supports the integrated circuit is affixed to thin-film battery 102. In other embodiments of the present invention, device 106 is other of various electrical circuit elements well known to those of ordinary skill in the art, such as passive electrical circuit elements or active electrical circuit elements. Examples of passive electrical circuit elements include but are not limited to capacitors, inductors, and resistors. Examples of active electrical circuit elements include but are not limited to operational amplifiers, power supplies, DC-DC converters, and batteries. Examples of coating 116 are insulating glass, such as spin-on glass, a deposited glass, a nitride or other suitable encapsulant material.

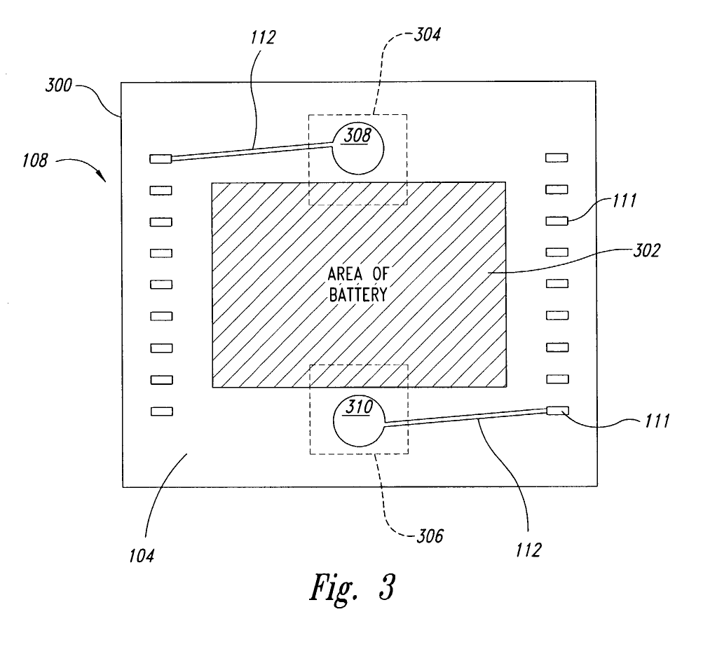

Continuing to refer to FIG. 1, circuitry of device 106 is electrically connected with thin-film battery 102. Specifically, circuitry of device 106 is electrically connected with bonding wire 120. Bonding wire 120 is electrically connected with bonding pad 111. Bonding site 111 is electrically connected with conductive trace 112. Conductive trace 112 is electrically connected with cathode current collector 122. Cathode current collector 122 is in direct contact with cathode 124. Device 106 is similarly connected with lithium anode 126 of thin-film battery 102 via similar bonding wires, bonding pads, conductive traces, and an anode current collector, as is clear from FIG. 3. The integrated circuit can thus obtain power from the lithium battery it is positioned over. Electrolyte 125 resides between and completely isolates cathode 124 from direct contact with lithium anode 126.

Continuing to refer to FIG. 1, encapsulant 107 encapsulates device 106 and thin-film battery 102. Encapsulant 107 may be formed by virtually any encapsulant process well known to those of ordinary skill in the art.

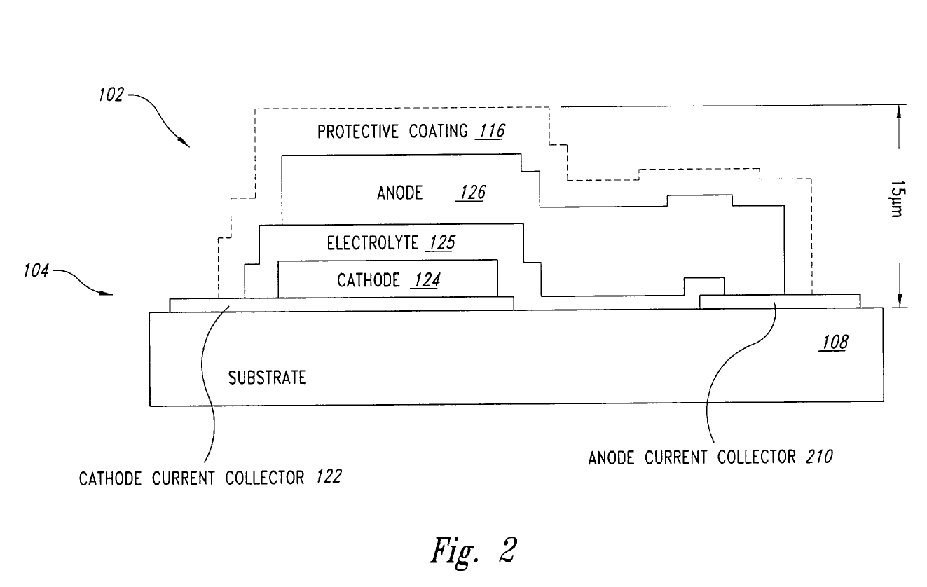

Referring now to FIG. 2, shown is an illustrative example of thin-film battery 102 used in one embodiment of the present invention. In one embodiment of the present invention, thin-film battery 102 is a type of lithium ion battery having a height of about 15 μm. In one embodiment, when the device 106 is an integrated circuit, the height of device 106 is about 250 μm. The device 106 and battery 102 are not shown to scale in FIG. 1; the battery 102 is approximately 10 to 20 times thinner than the device 106 in many embodiments. The unit 105 is also not drawn to scale with the entire apparatus 100, since the apparatus 100 may be 10 to 100 times larger than the unit 105.

Examples of lithium batteries are those with crystalline LiCoO₂ cathodes, nanocrystalline LiMn₂O₄ cathodes, crystalline LiMn₂O₄ cathodes. The battery 102 may also be a lithium-ion battery with crystalline LiCoO₂ cathode, or lithium phosphorous oxynitride (“Li-ion”) electrolyte. It may have a lithium anode or a lithium-ion anode, such as SiTON, SnNₓ or InNₓ.

It may also be a “lithium-free” thin film battery that is fabricated with only an anode current collector and the protective overlay. In such a “lithium-free” battery, upon the initial charge of the battery, a metallic lithium anode is plated in situ at the current collector. The lithium anode can be plated and stripped reversibly. One advantageous feature of the batteries disclosed herein, including the “lithium-free” thin film battery is the capacity and discharge rates are as high as batteries with an evaporated lithium anode. The cells can be cycled thousands of times. The newly fabricated battery can be heated to 250° C. prior to being charged.

Continuing to refer to FIG. 2, thin-film battery 102 is formed on surface 104 and is composed of cathode 124, electrolyte 125, anode 126, and protective coating 116.

Cathode 124 and anode 126 respectively electrically connect with cathode current collector 122 and anode current collector 210. In one embodiment, cathode current collector 122 and anode current collector 210 are formed contiguous with their respective connections of thin-film battery 102. In another embodiment, cathode current collector 122 and anode current collector 210 form a part of surface 104 such that when thin-film battery 102 is placed on surface 104 (see FIG. 3), cathode current collector 122 and anode current collector 210 respectively align with their respective connections on thin-film battery 102. In yet another embodiment the collectors are formed on different structures (e.g., cathode current collector 122 is formed contiguous with its respective connection of thin-film battery 102 and anode current collector 210 forms a part of surface 104). In certain implementations, thin-film battery 102 is formed as part of a process of constructing a semiconductor device package or the semiconductor device itself.

In one implementation, thin-film battery 102 is a lithium battery which is formed in a substantially discharged state such that the lithium forms a compound rather than pure lithium thus permitting the battery to be subjected to high temperatures prior to being charged to store power. This may also be used for the lithium cathode as well. The temperature the unit experiences during production of the integrated circuit package and solder connections can thus be quite high and still provide stable charging and discharging. The temperature is kept below that temperature at which the discharged battery is damaged.

With reference now to FIG. 3, shown is one implementation of surface 104 used in one embodiment of the present invention. Depicted is a top-plan view of substrate 108 upon which is inscribed area 302 which forms the expected footprint of thin-film battery 102 on surface 104. Also inscribed on substrate 108 are anode current collector footprint 304, and cathode current collector footprint 306. In some embodiments, the anode collector footprint 304 is the same structure as the anode collector 210 and the cathode collector footprint 306 is the same structure as the cathode collector 122, both of which are formed integrated with the battery 102 when it is formed. Metallized areas 310 and 308 are positioned to respectively electrically contact the anode current collector 210 and cathode current collector 122 when anode current collector 210 and cathode current collector 122. Metallized areas 310 and 308 are electrically connected with conductive traces 112. Conductive traces 112 are electrically connected with the appropriate wire bonding sites 111. Other of the wire bonding sites 111 are electrically connected to other portions of the integrated circuit 106. The integrated circuit contains bonding pads, which electrically connect to operational circuits, such as a microprocessor, a memory, or other components within the integrated circuit. Power is thus supplied from the battery 102 to the integrated circuit via the trace 112 and the bonding wires. The integrated circuit 106 operates using this power and provides electrical signal output, which may include data or other control signals via the other bonding pads 111. Thus, with the integrated circuit positioned within a smart card, the source of the power can be encapsulated within the same protective coating 107 as the integrated circuit and provide stable power to the integrated circuit and also be repeatedly charged if it is discharged during operation.

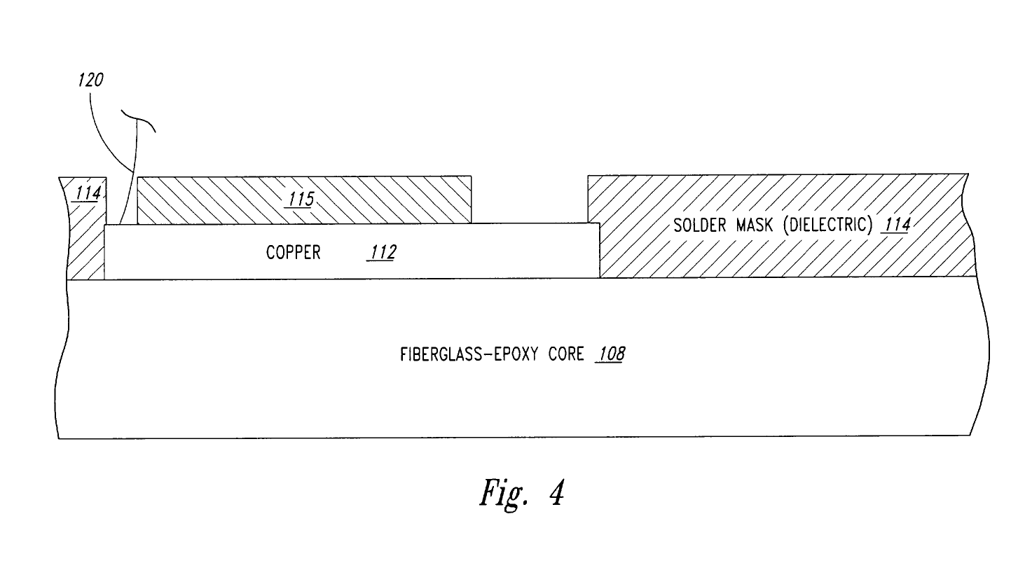

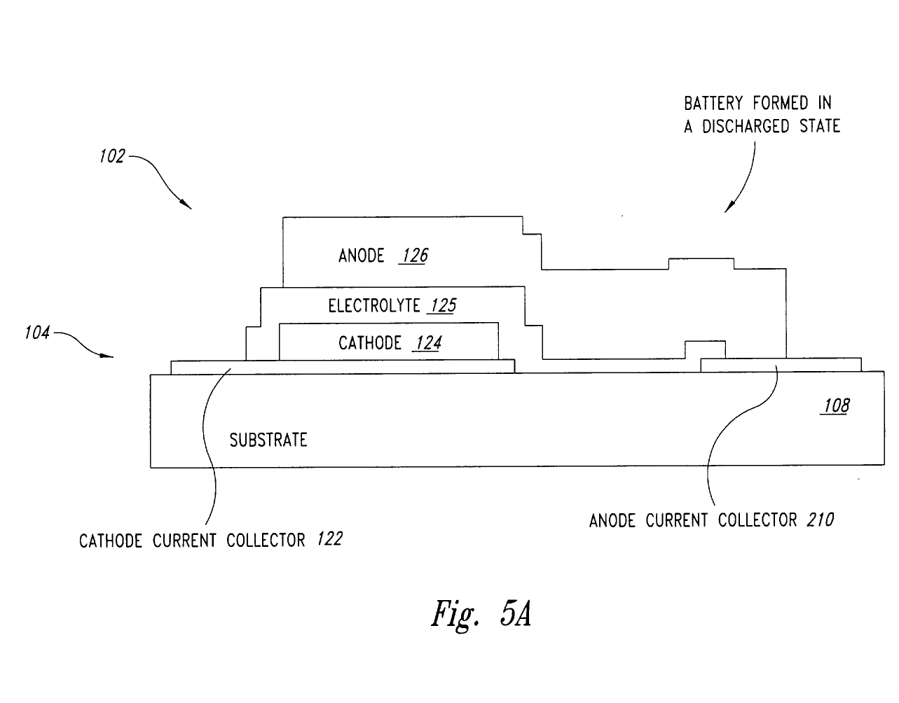

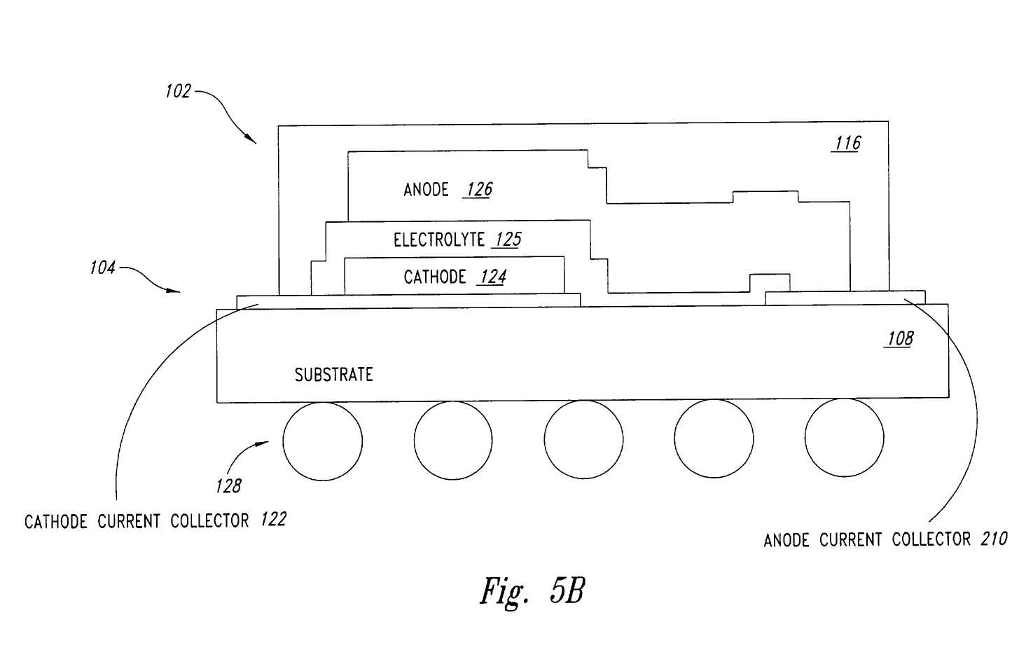

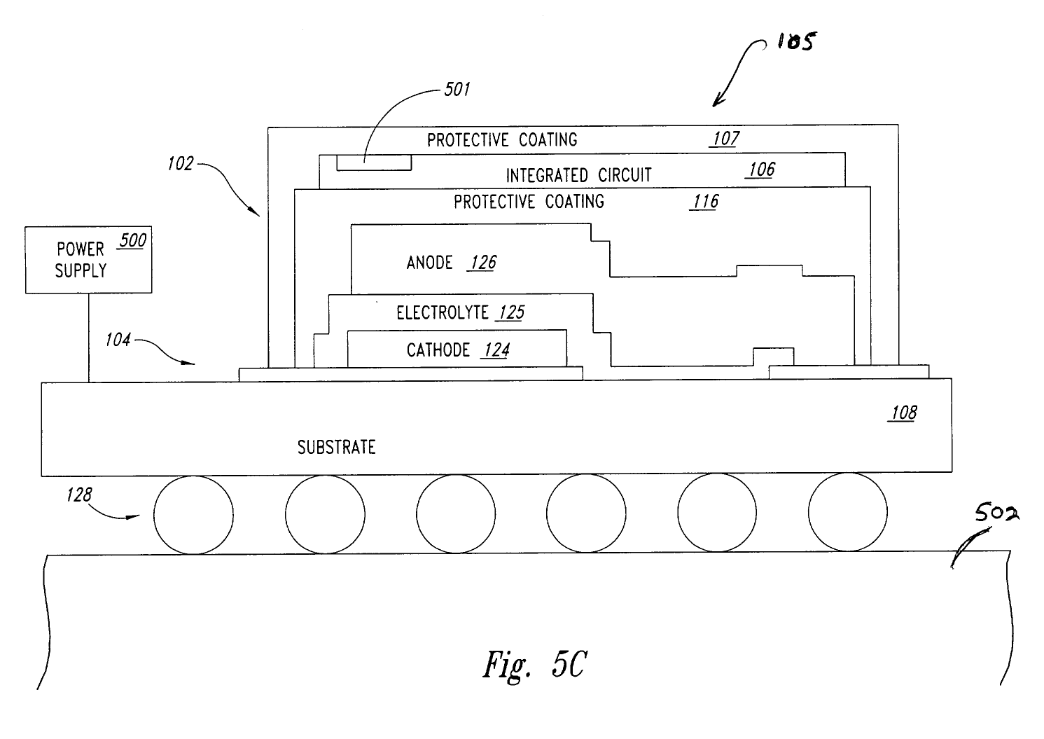

Referring now to FIG. 4, depicted is a side-plan view of a structure that may be used to create an implementation of surface 104 using substrate 108. Illustrated is that in one implementation substrate 108 is composed of a fiberglass-epoxy core. Layer 112 is copper in one embodiment that is deposited on fiberglass-epoxy core 108, and then etched to created conductive traces (e.g., conductive traces 112), bonding sites (e.g., bonding site 111), and metallized areas (e.g., metallized areas 308, 310). Thereafter, in one embodiment, dielectric layer 114 is created via a solder masking operation thereby forming an implementation of surface 104. The substrate 108 may be any acceptable substrate used in the manufacture of semiconductor products. According to one embodiment, the substrate 108 is a printed circuit board constructed using conventional techniques which are well known in the art. Such printed circuit boards include on upper and lower portions thereof electrically conductive traces for connecting various electrical components which may include a plurality of integrated circuits to each other and to other electrical circuits both on the printed circuit board and off the printed circuit board. Also, a large number of electrically conductive traces are within the inner layers of the substrate 108. Providing such electrical conductive traces on the surface or sandwiched in between insulated layers of the substrate 108 is well known in the art and can easily be accomplished using in any acceptable substrate 108 a suitable for use with this invention and therefore the details of formation and the numerous structures which can be used are not shown in detail. The substrate 108 is therefore to be understood as a generic substrate which may be selected from any of the many available in the art. As further examples, the substrate 108 may be a chip carrier package for use with a single integrated circuit. Alternatively, it may be a ball bond grid array package. Often, such ball grid array packages are assembled one per integrated circuit and are directly attached to the die either, through the top side thereof via a ball grid array or, using solder balls connected to the bottom side as shown hereafter in FIGS. 5B and 5C. Thus, the substrate 108 may also be of the type used with ball grid arrays for providing electrical connection to the integrated circuit. The same substrate 108 which is used to support the integrated circuit is also used to support the battery positioned underneath the integrated circuit thus providing substantial savings with space and simplifying construction.

According to principles of the present invention, this allows thin film batteries to be incorporated into integrated circuits by the solder reflow process. In particular, some solder alloys have a reflow temperature in the range of 210-220° C. Some lead free solders have reflow temperatures which are even higher, in the range of 250-260° C. Conventional batteries have their operational characteristics either destroyed or substantially impaired if they are heated to temperatures at or even below 200° C. Accordingly, it has not been previously possible, in the absence of the present invention, to attach a battery to a printed circuit board, or some other integrated circuit component, after which a solder reflow process is carried out.

With reference now to FIGS. 5A-5C, illustrated are side-plan views of structures representative of a method for constructing a device having a thin-film battery. Referring now to FIG. 5A, shown is thin-film battery 102 formed, in a substantially discharged state, proximate to surface 104. An example of forming a thin-film battery 102 in a substantially discharged state, proximate to surface 104, is forming anode 126 and cathode 124 of a thin-film battery such that during a subsequent battery charging, lithium provided by cathode 124 (typically LiCoO₂) reacts with anode 126 material producing conductive nanocrystalline Li—Sn alloy particles embedded in an amorphous matrix. Another example of forming a thin-film battery 102 in a substantially discharged state, proximate to surface 104, is forming a lithium anode of a thin-film lithium battery in a lithium-composite state. Another example of forming a thin-film battery in a substantially discharged state, proximate to surface 104, is forming a lithium anode of a thin-film lithium battery in an amorphous lithium state.

According to principles of the present invention, a thin-film lithium battery is formed, according to conventional techniques, onto a selected substrate 108 which is previously designed and prepared for use with an integrated circuit. The substrate 108 thus has the appropriate electrical insulation layers and electrically conductive layers in place to be later used for an integrated circuit package carrier, a printed circuit board, or some other component. As a first step, the substrate 108 is prepared having structure and components for later use with an integrated circuit as explained herein. Subsequently, a lithium thin-film battery is formed onto the substrate 108. The sequence, and method, for forming a lithium thin-film battery are well known in the art and are described on the Oakridge National Laboratory website which is described in detail and incorporated by reference later herein. In summary, the appropriate dielectric layers on the substrate 108 are provided in combination with the appropriate electrical contacts. A cathode and/or cathode collector is deposited onto the substrate 108 using techniques conventional to the formation of lithium thin-film batteries. Afterward, the subsequent steps are carried out to form the electrolyte 125, anode 126, and protection layer 116 so as to complete the formation of the lithium battery onto the substrate 108. Any technique for forming the lithium battery on the previously prepared substrate 108 is acceptable, numerous techniques being known in the art. After the thin-film battery 102 is formed, it remains in the discharged state. In one embodiment, the lithium therein is not in the pure metallic state, but remains in a compound. Since the battery is in the discharged state, it can be subjected to substantially high temperatures, in excess of 260° C. Accordingly, the substrate 108 may be later connected with electrical circuits using solder, or a solder reflow technique, as will now be described.

With reference now to FIG. 5B, depicted is attaching structures to thin-film battery 102, where the attaching is done at a temperature greater than or equal to that necessary to achieve the attaching but less than that which would substantially damage thin-film battery 102 in the substantially-discharged state. An example of attaching a structure to thin-film battery 102 at a temperature greater than or equal to that necessary to achieve the attaching, but less than that which would substantially damage thin-film battery 102 in the substantially-discharged state, is applying heat proximate to surface 104 at a temperature greater than or equal to that necessary to partially melt epoxy resin, such as would be done if conductive epoxy resin were used to affix thin-film battery 102 to substrate 108. Another example of attaching structure to thin-film battery 102 at a temperature greater than or equal to that necessary to achieve the attaching, but less than that which would substantially damage thin-film battery 102 in the substantially-discharged state, is applying heat proximate to surface 104 at a temperature greater than or equal to that necessary to partially melt solder (e.g., a temperature of 250 degrees Centigrade), such as solder (not shown) used to affix ball grid connector 128 to substrate 108. Another example of attaching a structure to thin-film battery 102 at a temperature greater than or equal to that necessary to achieve the attaching, but less than that which would substantially damage thin-film battery 102 in the substantially-discharged state, is applying heat proximate to surface 104 at a temperature greater than or equal to that necessary to partially melt a portion of ball grid connector 128.

There are several thin-film battery formation processes, and batteries, that can be utilized with the described high-heat attaching. Examples of such thin-film battery formation processes, and batteries, are those described on the Oak Ridge National Laboratory web site at, for example the URL http://www.ssd.ornl.gov/programs/BatteryWeb/xxx, the content of such web site being hereby incorporated by reference in its entirety and the letters xxx serving as an example of including all the various subsections within this main web page.

After the structure of FIG. 5B is completed, an integrated circuit is placed on top of the protective coating 116 and the appropriate bonding wires are attached to provide electrical connection to the substrate 108 as shown in FIG. 1. In some embodiments, a final encapsulant will be provided at this stage to provide a complete integrated circuit and battery package 105. In alternative embodiments, the encapsulation layer 107 will not take place at this time, but rather will occur later in the process. After the integrated circuit 106 is connected to the substrate 108, the entire assembly may then be connected to a larger printed circuit board or connected to another electrical component in the system using the solder reflow process during which the entire structure is subjected to temperatures in excess of 200° C., and potentially temperatures in the range of 250-260° C. Namely, during the solder reflow process solder balls 128, as shown in FIG. 5B are brought adjacent to another substrate or structure to which they are to be electrically connected. Of course, appropriate electrical connections are provided from the electrical circuit 106 through the substrate 108 to the appropriate solder balls for providing electrical data connections and power supplies, as is appropriate for the integrated circuitry within the particular application. The solder balls are then taken to a sufficient temperature to cause reflow and electrical connection to the additional substrate 502 as indicated in FIG. 5C. The combination package 105 may also undergo additional processing which may include additional heat treatment steps such as the sealing within an epoxy encapsulant using transfer molding in which epoxy or some other resin is floated to very high temperature to surround the entire unit 105. All of these steps are carried out while the battery 102 is in the discharge state and subsequently, the battery is then charged to store power and to provide power as needed to the integrated circuit as will now be described.

Referring now to FIG. 5C, illustrated is power supply 500 for charging thin-film battery 102, where thin-film battery 102 was previously formed and heated in a substantially discharged state, such as shown and described in relation to FIGS. 5A and 5B. The charging of thin film battery 102 occurs subsequent to forming thin-film battery 102 in the substantially discharged state. By forming thin-film battery 102 in a substantially-discharged state, and thereafter charging thin-film battery 102, it has been found that thin-film battery 102 can be subjected to high heat manufacturing processes which heretofore could not be withstood by batteries. In some embodiments, subsequent to thin-film battery 102 being formed in a substantially discharged state, the thin-film battery 102 is subjected to multiple high-heat processes, and thereafter thin-film battery 102 is charged subsequent to the last high-heat process. Forming thin-film battery 102 in a substantially discharged state proves particularly useful when used with the other subject matter disclosed herein.

The power supply 500 can be connected to any acceptable location to the integrated circuit and battery package unit 105. According to one embodiment of the present invention, power supply 500 is provided to the substrate 108 to permit subsequent charging of the battery 102. According to principles of the present invention, the power supply 500 is provided to the substrate 108 and then is provided via the appropriate bonding wires 120 to the integrated circuit 106. The integrated circuit 106 has thereon a charging circuit 501. The charging circuit 501 has the appropriate components for charging the battery at the appropriate voltage and with the proper control circuits. For example, it may include transistors and capacitors as well as voltage regulators in order to properly charge the battery 102. The power supply 500 is therefore provided to the integrated circuit 106. After the integrated circuit 106 receives the power, then the battery charge circuit 501 provides power to the battery 102 and charges the battery so that it now becomes fully charged. The battery is maintained in the fully charged state under control of the integrated circuit 106. As appropriate, the power stored in the battery 102 is provided as an output to the integrated circuit 106 to maintain the proper power to other circuits on the chip. Alternatively, the power is provided to other integrated circuits on either the substrate 108 or the substrate 502.

Alternatively, the battery charge circuit 501 is not an integrated circuit 106. In such an alternative embodiment, the battery charge circuit 501 may be on a different circuit on the larger substrate 502 having other integrated circuits thereon or may be part of the power supply 500. In such an instance, power is provided via the solder connections 128 directly to the electrical contacts on the battery 102 to properly charge the battery after all the solder connections are completely made. The charging of the battery may therefore be carried out via the very same solder connections which were subjected to high temperature after the battery was formed, but prior to the charging thereof.

The substrate 502 may be a printed circuit board, an electrical component in a larger system, such as a smart card, a cell phone, or other component. The substrate 502 preferably contains a large number of other integrated circuits or components which are appropriately connected, some of which are connected by the solder technique after the integrated circuit and battery unit 105 are connected to the substrate 502.

The present invention is particularly advantageous in some applications, such as smart cards or other very small devices, where electric power storage is desired together with a low cost of assembly. Prior to this invention, it was necessary to form a substantial part of the integrated circuit package and, at a final step, provide the battery after all other soldering and other high temperature steps in excess of the battery operational temperature had been completed. Typically, batteries operate in temperature ranges below 100° C. and, most batteries are rated to withstand temperatures less than 120° C., or in some 140° C. Accordingly, it was required to substantially form the entire product and as a final step insert the battery into the completed product. According to the present invention, the battery can be formed integral with the integrated circuit package. The entire integrated circuit package 105, which includes the battery, can now be connected into another component, such as a smart card so that the entire assembly can be completed in a single step and mass produced at relatively low cost.

The foregoing described embodiments depict different components contained within, or connected with, different other components. It is to be understood that such depicted architectures are merely exemplary, and that many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the scope of this invention. Furthermore, it is to be understood that the invention is solely defined by the appended claims. It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

1. An apparatus comprising:
a thin-film battery affixed to at least one surface; and
a device affixed to said thin-film battery.

2. The apparatus of claim 1, wherein said thin-film battery affixed to at least one surface comprises:
an anode of said thin-film battery electrically coupled to an anode current collector proximate to the at least one surface.

3. The apparatus of claim 2, wherein said anode of said thin-film battery electrically coupled to an anode current collector proximate to the at least one surface comprises:
said anode of said thin-film battery electrically coupled to a conductive substance of a semiconductor package substrate.

4. The apparatus of claim 1, wherein said thin-film battery affixed to at least one surface comprises:
a cathode of said thin-film battery electrically coupled to a cathode current collector proximate to the at least one surface.

5. The apparatus of claim 4, wherein said cathode of said thin-film battery electrically coupled to a cathode current collector proximate to the at least one surface comprises:
said cathode of said thin-film battery electrically coupled to a conductive substance of a semiconductor package substrate.

6. The apparatus of claim 1, wherein said thin-film battery affixed to at least one surface comprises:
said thin-film battery affixed to a semiconductor package substrate.

7. The apparatus of claim 6, wherein said thin-film battery affixed to a semiconductor package substrate comprises:
said thin-film battery affixed to a ball grid array semiconductor package substrate.

8. The apparatus of claim 1, wherein said thin-film battery affixed to at least one surface comprises:
said thin-film battery having a height of substantially 15 micrometers or less.

9. The apparatus of claim 1, wherein said thin-film battery affixed to at least one surface comprises:
said thin-film battery having a height substantially less than a height of an integrated circuit substrate.

10. The apparatus of claim 1, wherein said thin-film battery affixed to at least one surface comprises:
a lithium anode thin-film battery affixed to the at least one surface.

11. The apparatus of claim 1, wherein said device affixed to said thin-film battery comprises:
an integrated circuit affixed to said thin-film battery.

12. The apparatus of claim 11, wherein said integrated circuit affixed to said thin-film battery comprises:
an integrated circuit substrate affixed to at least one surface of said thin-film battery.

13. The apparatus of claim 11, wherein said integrated circuit component affixed to said thin-film battery comprises:
at least one electric circuit electrically connected with said thin-film battery via an electrically conducting structure.

14. The apparatus of claim 1, wherein the apparatus comprises:
a computer system of a computer-system group including but not limited to a handheld computer system, a personal computer system, a workstation computer system, a minicomputer system, and a mainframe computer system.

15. The apparatus of claim 1, wherein the apparatus comprises:
a wireless device of a wireless-device group including but not limited to a wireless phone, a wireless handheld computer, a wireless modem, a wireless email unit, and a Global Positioning System locator.

16. An apparatus comprising:
a thin-film battery affixed to a substrate; and
an integrated circuit affixed to and overlying said thin-film battery.

17. The apparatus of claim 16, wherein the substrate is a semiconductor package substrate.

18. The apparatus of claim 16, comprising:
an insulating layer interposed between said thin-film battery and said integrated circuit.

19. The apparatus of claim 16, wherein said integrated circuit affixed to and overlying said thin-film battery comprises:
said thin-film battery having a height substantially less than a height of an integrated circuit substrate.

20. The apparatus of claim 16, wherein said thin-film battery comprises:
a lithium anode thin-film battery.

21. The apparatus of claim 16, wherein said integrated circuit affixed to and overlying said thin-film battery comprises:
an integrated circuit substrate affixed to at least one surface of said thin-film battery.

22. The apparatus of claim 16, wherein said integrated circuit affixed to and overlying said thin-film battery comprises:
at least one electric circuit electrically connected with said thin-film battery.

23. A method for making an apparatus, said method comprising:
forming a thin-film battery; and
affixing a device to the thin-film battery.

24. The method of claim 23, wherein said forming a thin-film battery comprises:
depositing at least one of an anode, an electrolyte, and a cathode of the thin-film battery.

25. The method of claim 23, wherein said forming a thin-film battery comprises:
depositing a lithium anode of the thin-film battery proximate to at least one surface.

26. The method of claim 23, wherein said forming a thin-film battery comprises:
forming at least one of an anode current collector conductive region and a cathode current collector conductive region.

27. The method of claim 26, wherein said forming at least one of an anode current collector conductive region and a cathode current collector conductive region comprises:
patterning a dielectric overlying a conductive material on a semiconductor package substrate.

28. The method of claim 23, wherein said affixing a device to said thin-film battery comprises:
affixing an integrated circuit to at least one surface of the thin-film battery.
